(19) United States
(12) Patent Application Publication
(10) Pub. No.: US 2007/0256043 A1
(43) Pub. Date: Nov. 1, 2007

(54) Method and system for implementing a mass data change tool in a graphical user interface

(76) Inventors: Johan C. Peters, St Leon-Rot (DE); Tobias Haug, Heidelberg (DE); Udo Arend, Heidelberg (DE); Jens C. Bombolowsky, Schwetzingen (DE)

Correspondence Address: KENYON & KENYON LLP, ONE BROADWAY, NEW YORK, NY, 10004, US

(21) Appl. No.: 11/415,806

(22) Filed: May 1, 2006

(51) Int. Cl. G06F 17/50

(52) U.S. Cl. 716/11; 716/16

(57) ABSTRACT

A method and system are provided for implementing a mass data change tool to update the column data for the selected rows in a table presented in the graphical user interface of a software application. The mass data change tool may include an additional row, a mass data change row, in the table and an initiation means to trigger the mass data change. The additional mass data change row may contain input fields for one more columns of the table for which mass data updating is provided. These input fields may be used to specify valid field values to update the selected rows of the table. The initiation means may be a button or other graphical icon in the additional mass data change row of the table. The initiation means for the mass data change tool may include any known initiation means such as a pull-down menu option or button on the graphical user interface.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates to a method and system for implementing a versatile tool in a graphical user interface to facilitate the mass updating of data in multiple rows of a table initiated by a single operation.

### BACKGROUND

Many software applications present tables of data or information to a user through a graphical user interface. In some cases these tables may contain information that may be read only and in other cases a software application may allow a user to modify the data in the table. For example, the application may allow a user to add, delete, and update rows of stored data. When a software application allows a user to update the contents of a table, the data modification process (updating existing rows of data) generally requires row-by-row changes thereby making the data modification process more labor intensive for the user. For example, a user typically updates data in a table of a software application's graphical user interface one cell at a time. A cell, the intersection between a column and row, contains a single data item within the row and is a single entry for the column of the table. If a user wants to set a particular value for the column in several rows of the table, this must be done one by one for each row (i.e., for each cell in each row). Similarly, if a user wants to update the column value in multiple cells of a row, each cell in each row must also be updated separately.

Software applications typically lack a tool in the graphical user interface allowing the user to update the value of a column for multiple rows in the table in a single initiated operation. Such a tool may prove efficient and beneficial for users where a number of column values are being updated. For example, in a table containing purchase order information that includes a column “Processed”, which contains a “yes” or “no” value to indicate whether the purchase order was processed, a user may need to update the “Processed” field or cell value for each row one at a time. Software applications also typically lack a tool in the graphical user interface allowing a user to update the value of multiple columns in one or more rows of the table in a single initiated operation. For example, typically a user must update the value of a first column in a row before the user can then update the value of a second column and the user must update each column separately for each row.

The present invention presents an innovative method and system for implementing the mass updating of data in a table. This mass data change may be implemented as part of a single initiated operation instead of requiring the user to execute multiple operations in the graphical user interface of the software application.

### BRIEF DESCRIPTION OF THE DRAWINGS

FIG. 1 is a diagram illustrating the application environment in which the mass data updating tool operates according to one embodiment of the present invention.

FIG. 2 is a screen shot of a software application displaying a table with an option for the use of a mass data updating tool according to one embodiment of the present invention.

FIG. 3 is a diagram illustrating a table of a graphical user interface implementing a mass data updating tool according to one embodiment of the present invention.

FIG. 4 is a diagram illustrating a table of a graphical user interface implementing a mass data updating tool according to one embodiment of the present invention.

FIG. 5 is a diagram illustrating a table incorporating a mass data update tool after the tool is used to implement selective updates to the table data according to one embodiment of the present invention.

FIG. 6 is a block diagram illustrating the platform on which a mass data updating tool in a table of graphical user interface may operate according to one embodiment of the present invention.

### DETAILED DESCRIPTION

A method and system are provided for implementing a mass data updating tool (also referred to interchangeably herein as the mass data change tool) in a table of a graphical user interface of a software application. According to one embodiment of the present invention, the mass data updating tool is presented as an additional mass change row of the table and an initiation means for the mass data update. The additional mass change row of the table may contain input fields for one more columns of the table for which mass data updating is provided by the mass data updating tool. These input fields may be used to specify valid field values which may be used to update the selected rows of the table when the mass data update is initiated using the initiation means. In this embodiment, the mass data updating tool may be used to change the column value in one or more columns for the selected rows of the table. In one embodiment of the present invention, the initiation means may be a button or other graphical icon in the additional mass change row of the table. In an alternative embodiment, the initiation means for the mass data update may be external to the mass change row of the table and may include any known initiation means such as, for example, a pull-down menu option or button on the graphical user interface of the software application. The mass data update may be performed on selected rows of the table where row selection is possible such as for example using a checkbox column to select rows or by highlighting selected rows (e.g., using ctrl-click or shift-click on the selected rows) according to one embodiment. If row selection is not possible or is otherwise limited to a single row, the mass data update may be performed on the entire table according to an alternative embodiment of the present invention.

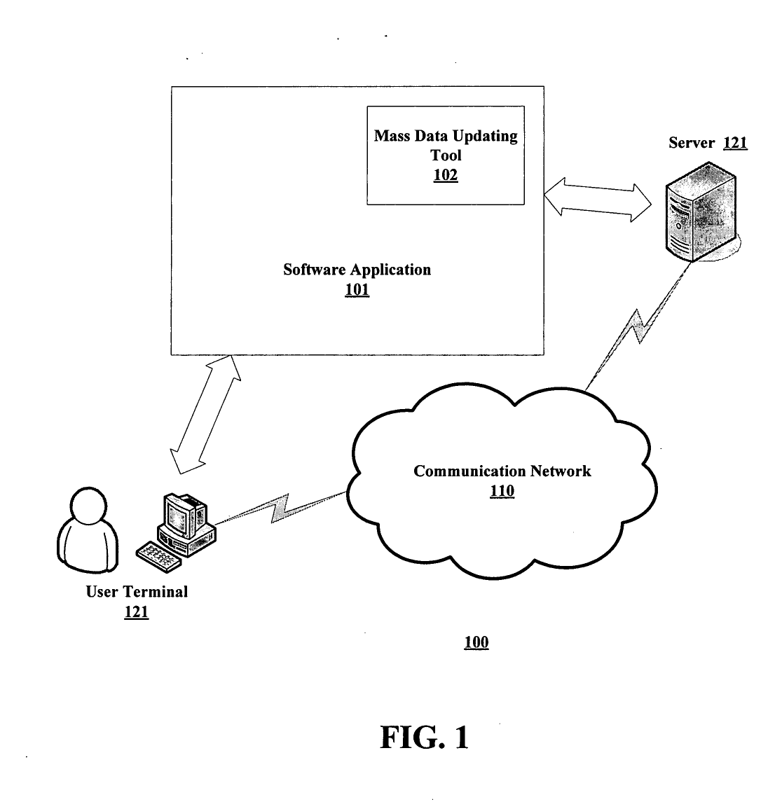

FIG. 1 is a diagram illustrating the application environment in which the mass data updating tool operates according to one embodiment of the present invention. The mass data updating tool 102 may consist of one or more software applications, programs, modules, procedures, or other computer code to include firmware and may additionally include stored data that may be part of the software application 101 it works with (shown) or it may be external to the software application 101 (not shown) where it modifies the presentation of the graphical user interface to implement the mass data change functionality according to alternative embodiments of the present invention. In the embodiment of the application environment 100 shown, the mass data updating tool 102 is part of the software application 101 and resides on a server 121. In other embodiments, the software application 101 and/or the mass data update tool 102 may reside on one or more servers, computers, or other hardware platforms of the application environment 100. In the embodiment shown 100, the server 121 is connected to a user terminal 122 by a network 110, such as for example the internet. The software application 101 and the mass data updating tool 102 are stored on the server 121 and are loaded, in whole or in part, to the user terminal 122 over the communication network 110 when the user initiates or otherwise calls the software application 101. The software application 101 presents the graphical user interface on the user terminal 122. In other embodiments of the present invention, the software application 101 may be loaded on a single computer instead of the network environment shown 100 or the software application 101 and/or the mass data updating tool 102 may be stored in whole or in part on both the user terminal 122 and the server 121. The application environment 100 shown is only one possible implementation of the mass data updating tool 102 in conjunction with the software application 101.

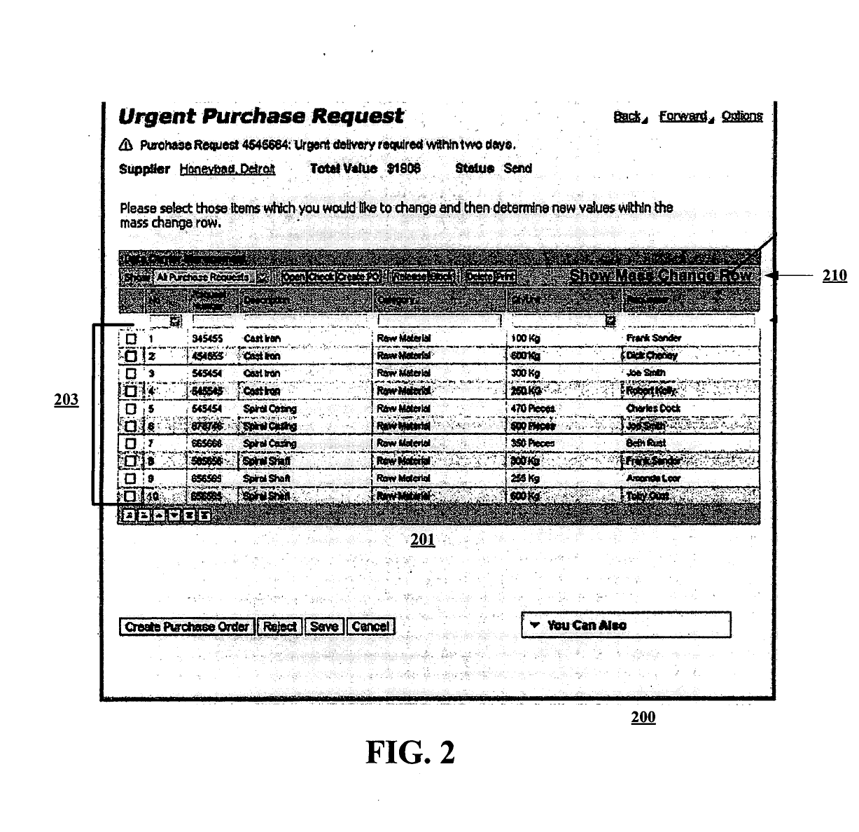

The mass data updating tool may consist of one or more initiation means, mass change row, and/or one or more selection means according to one embodiment of the present invention. FIG. 2 is a screen shot of a software application displaying a table with an option for the use of a mass data updating tool according to one embodiment of the present invention. The screen shot 200 includes a purchase order table 201 containing data regarding a number of purchase orders the user has placed. In this embodiment, a selection means to select one or more rows of the table is already provided by the inclusion of a checkbox column 203 at the left of the table 201. The table 201 does not show a mass data updating tool 102 but instead includes an option “Show Mass Change Row” 210 that allows the user to toggle the mass data updating tool 102 on or off (i.e., visible or hidden) for the table 201. If the user toggles the mass data updating tool on (i.e., makes the tool visible for the table), an additional mass change row is shown in the table and the initiation means may then become available. The initiation means may be, for example, a table control or other known operation initiation means (e.g., a pull-down menu option or button). The implementation of the mass data updating tool according to one embodiment of the present invention may result in the additional mass change row shown in the table and the initiation means shown either in the table or elsewhere on the graphical user interface of the software application.

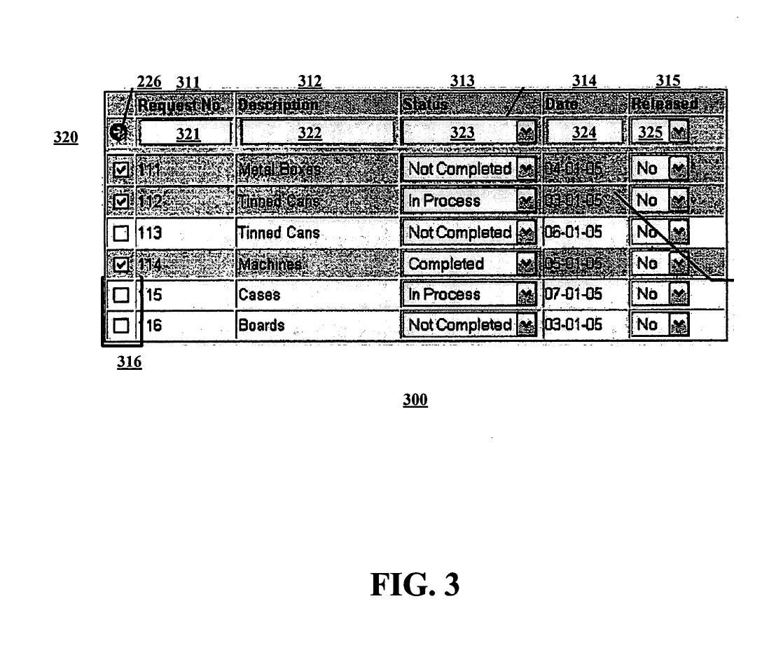

FIG. 3 is a diagram illustrating a table of a graphical user interface implementing a mass data updating tool according to one embodiment of the present invention. According to this embodiment, the table 300 includes five (5) columns of data: “Request No.” 311, “Description” 312, “Status” 313, “Date” 314, and “Released” 315. In addition to these columns 311-315, a checkbox column 316 is also included that facilitates the selection of rows in the table 300. This checkbox column 316 may be part of the graphical user interface representation of the table 300 allowing different tools or functions to use this provided selection means. In an alternative embodiment of the present invention, this checkbox column 316 is added to the graphical user interface representation of the table 300 as part of the mass data updating tool. In either embodiment, a check in the checkbox cell of a row may be used to indicate a selected row for a mass data updating operation. In addition to the checkbox value, selected rows may also be indicated by highlighting the row. For example, the row of the table 300 for request number 111, 112, and 114 are highlighted in addition to each associated row having its checkbox checked in the checkbox column 316 with both items (i.e., the highlighting and the check in the checkbox) indicating that the row of data is selected.

Graphical elements of the mass data updating tool are integrated into the table in a mass change row 320 underneath the headers for the columns in the table 300. These graphical elements 320 include data update fields 321-325 corresponding to the columns 311-315 of the table 300. In addition, an action initiation button 326 is also included as an initiation means in the graphical elements of the mass data updating tool shown in the embodiment depicted in FIG. 3.

According to one embodiment of the present invention, a user may make a change to the data in several rows of the table at one time by using the mass data updating tool. The graphical user elements of this tool are primarily shown in the first row 320 of the table. The graphical user elements included in this embodiment begin with an action initiation button 326. When the user clicks or otherwise selects this button 321, the designated changes are executed on the corresponding data in the selected rows of the table. For each of the data columns of the table 311-315, a corresponding field 322-326 is included in the mass change row 320 of the tool. The user may make changes to the column data for the selected rows by entering the new information in the associated column field of the mass change row 320 of the tool. For example, the user may change a date in the data column 314 for the selected rows by entering the new (updated) date value in the corresponding date column 324 in the mass change row 320 the mass data updating tool and then by initiating the operation by executing the action initiation button 326 (i.e., the initiation means). One particular advantageous feature of the mass data updating tool is the ability to make changes to not only multiple selected rows in a single operation but also the ability to make changes to multiple columns of data in a single operation. For example, a user may enter an updated date in the corresponding data field 324 and an updated status in the corresponding status field 323 in the mass change row 320 of the mass data updating tool. When the user initiates the mass data update operation by, for example, clicking on the action initiation button 326, the data for the “Date” column 314 and the “Status” column 313 for the selected rows is updated.

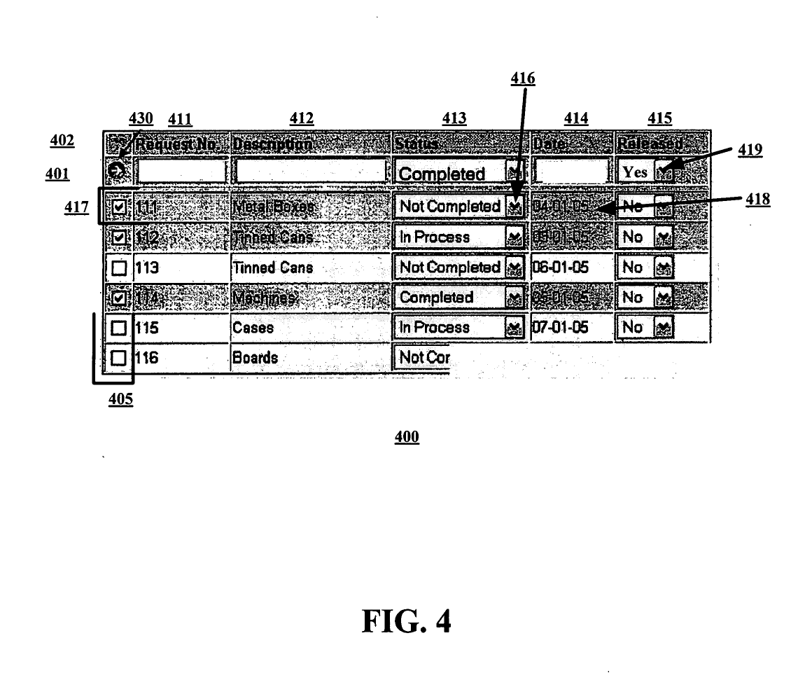

FIG. 4 is a diagram illustrating a table implementing a mass data update tool before any data is updated according to one embodiment of the present invention. The table 400 consists of five columns containing data from a business information management system used in the processing of purchase orders according to this embodiment of the present invention. The first column 411 contains the purchase request number which is a unique number identifying the purchase request. A description 412 of the item in the purchase order is shown in the second column 412. For example, the descriptions provided for this example include “Metal Boxes”, “Tinned Cans”, “Machines”, “Cases”, and “Boards”. The status 413 of the purchase order is in the third column and includes the values “Completed”, “Not Completed”, and “In Process”. Each cell (i.e., intersection of a row and column—in other words the value of a column for a particular row) in the table 400 for the status column 413 has a pull-down menu (a radio field) as indicated by the down arrow 416 to the right of the value in the cell. In this manner, a user may be restricted to selecting only one of a predefined set of values to include as the value for the cell. As previously stated there are 3 values in the set of values for this column 413 that are reflected throughout the example table 400 shown: “Completed”, “Not Completed”, and “In Process”. The fourth column 414 in the table 400 is the date on which the purchase request was received. For example, the purchase request in the first row 417 with purchase request number “111” was received on “04-01-05” 418. Whether the purchase request is released—meaning that it has been fulfilled and/or no further action needs to be taken—s indicated in the fifth column 415 of the table 400. This “Released” column 415 also contains a pull-down menu (radio field) limiting the possible values for this column to either “Yes” or “No” as is shown in various rows of the table 400.

The mass data updating tool may include one or more selection means and/or initiation means represented by certain graphical elements that are displayed along with the table in the graphical user interface of the software application. In the embodiment depicted in FIG. 4, several graphical elements that may be part of the mass data updating tool are shown. A checkbox column 405 is shown to the left of the first “Request No.” data column 411 of the table 400. In addition the mass data change row 401 of the table 400 shown immediately below the column headings 402 is also part of the graphical elements of the mass data updating tool according to this embodiment of the present invention as previously discussed. A user making a mass data update to the table may select the rows of the table that are to be changed using a selection means such as the checkbox column 405. These selected rows are indicated in FIG. 4 by a check in the checkbox column 405 as well as by the highlighting of the selected rows. A user also needs to specify the updates to be made in the respective columns of the selected rows of the table 400. In the example shown in FIG. 4, the user intends to change the status of the selected rows to “Completed” as is shown in the mass change row 401 status cell value 413. In addition, the user also intends to change the released column 415 value to “Yes” 419 for the selected rows. As previously discussed regarding the value of the cells in the table, the data format for the mass change row column values should directly correspond to the column data in the table. For example, in the released column 415 each of the cells in the table contains a value “Yes” or “No” from a predefined set of value (e.g., {Yes, No}) as indicated from pull-down menu (radio field) for the cell value. In one embodiment of the present invention, the mass data update tool restricts the allowable data for which a column may be updated to the same values and restrictions of the column in the table. Because in this example the column values are limited to a “Yes” or “No” value, the mass data update tool may also restrict the user selection in the corresponding update value for the column 419 in mass change row 401 to the same values of “Yes” or “No” according to this embodiment. In the example shown in FIG. 4, the extent of the data updates the user wants to make in this single operation have already been indicated by the selected column values and the selected rows. Columns without a data update value will remain unchanged according to this embodiment. When the user initiates the mass data update operation, the indicated changes will be implemented. One initiation means 430 for the mass data update is indicated by a clickable graphical icon (e.g., a button) shown in the mass change row 401 of the table 400 in the example embodiment shown in FIG. 4. Other initiation means may also be used in conjunction with or instead of this initiation means in other embodiments of the present invention.

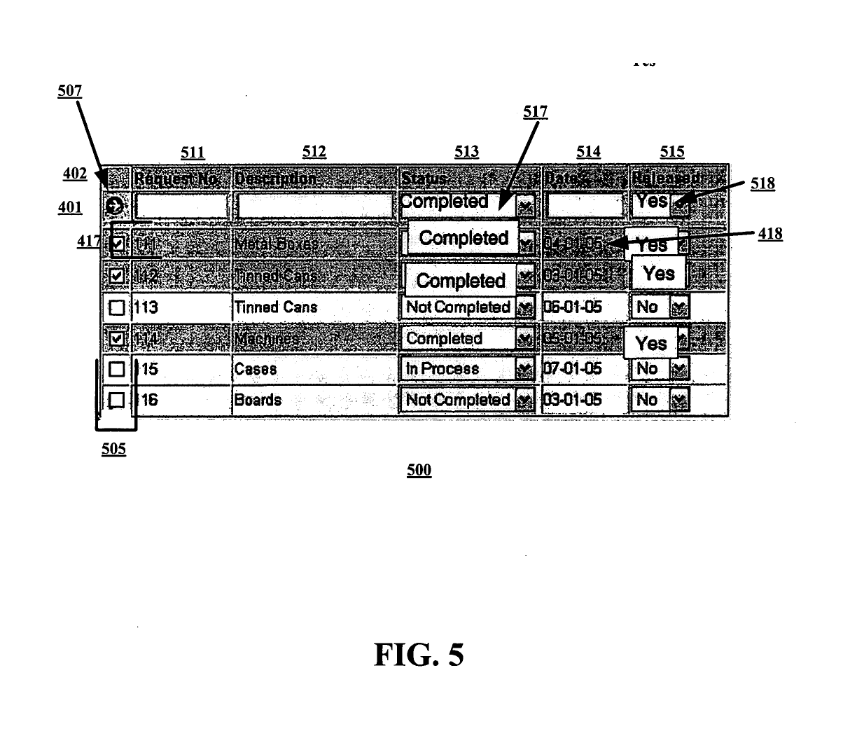

FIG. 5 is a diagram illustrating a table incorporating a mass data update tool after the tool is used to implement selective updates to the table data according to one embodiment of the present invention. FIG. 5 shows the changes resulting from the user initiated mass data update operation as indicated in FIG. 4. According to this embodiment of the present invention, the selected rows remain highlighted and checked to indicate that the mass data update occurred on these rows. This feature may assist the user in determining whether the changes were sufficient and accurate. In other embodiments of the present invention, the highlighting and/or the check in the checkbox column 505 may be cleared after the mass data update operation has completed. The data update values for the columns are still also shown according to this embodiment after the mass data update operation completes. This feature may assist a user in reviewing the changes and may also make it easier for a user to determine whether or not he/she wants to undo the mass data update operation. In this example, data was changed in the status column 513 and released column 515 of the table 500. In the example embodiment shown in FIG. 5, the status values for the selected rows in the table 500 were changed from their original values to the new data update value of “Completed” 517 and the released values for the selected rows was changed from their original values to the new data update value of “Yes” 518. In a single mass data update operation, the values of six (6) cells in this small table 500 were updated. In other embodiments of the present invention, a mass data update operation may be initiated on a table contain significantly more columns and with more selected rows. The greater the number of columns in the table and the larger the table size in terms of the number of rows of data, the greater the potential benefit and efficiency gain that can be achieved by using the mass data updating tool according to this embodiment of the present invention.

In the embodiment depicted in FIG. 5, the mass data update initiation button or icon 507 remains the same after the mass data update operation is executed as it was before the operation was initiated. In an alternative embodiment of the present invention, the mass data update initiation button or icon 507 may be replaced with another icon after a mass data update operation executes to indicate that the data shown in the mass change row columns of the mass data updating tool has already been changed for the selected rows. In this manner, a user may be able to see that the values still remain in the mass change row columns of the tool and the rows remain highlighted for informational purposes and not because the operation has yet to execute or that there was an error in the operation executing. The replaced mass data update initiation button icon 407 may be returned to its original icon when any of the data in the mass change row columns of the mass data update tool is changed or when any rows in the table are selected and/or deselected. In this manner when the display no longer reflects the mass data update operation that was last executed, the change in the icon to visually indicate that the operation has already executed is no longer necessary and the icon may be returned to its original state indicating that a mass data update operation may be initiated. In another embodiment, a “clear” option may also be presented to the user whereby the user may clear all the data in the mass change row columns of the mass data update tool and where the indication of selected rows (e.g., highlighted rows and/or checks in a checkbox column) may also be cleared. On clearing the data, the mass data update initiation button or icon will also be returned to its original icon form according this embodiment to indicate that a mass data update operation may be executed and that any data in the mass change columns and selected rows from that point forward no longer reflects an already executed mass data update operation.

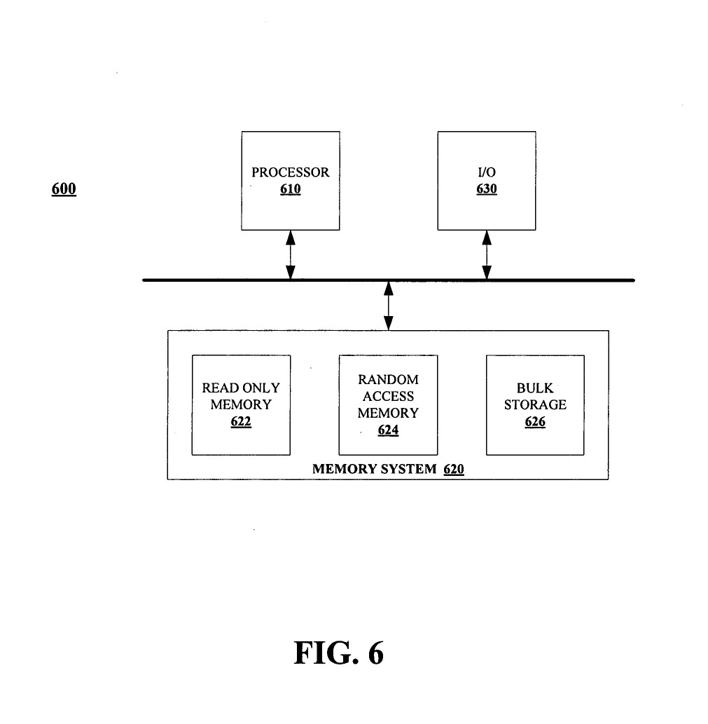

FIG. 6 is a block diagram illustrating the platform on which a mass data updating tool in a table of graphical user interface may operate according to one embodiment of the present invention. Functionality of the foregoing embodiments may be provided on various computer platforms executing program instructions. One such platform 600 is illustrated in the simplified block diagram of FIG. 6. There, the platform 600 is shown as being populated by a processor 610, a memory system 620 and an input/output (I/O) unit 630. The processor 610 may be any of a plurality of conventional processing systems, including microprocessors, digital signal processors and field programmable logic arrays. In some applications, it may be advantageous to provide multiple processors (not shown) in the platform 600. The processor(s) 610 execute program instructions stored in the memory system. The memory system 620 may include any combination of conventional memory circuits, including electrical, magnetic or optical memory systems. As shown in FIG. 6, the memory system may include read only memories 622, random access memories 624 and bulk storage 626. The memory system not only stores the program instructions representing the various methods described herein but also can store the data items on which these methods operate. The I/O unit 630 would permit communication with external devices (not shown).

1. A method for updating a column value in a plurality of rows in a table,: comprising:
identifying the plurality of rows in the table as a function of a provided selection means;
receiving an updated value for a column in the table as a function of a user input;
providing an initiation means to trigger the updating of the column value in the plurality of rows in the table; and
updating the column value in the identified plurality of rows in the table as a function of the received updated value and as a function of the triggered initiation means.

2. The method according to claim 1, wherein the table is displayed in a graphical user interface of a software application.

3. The method according to claim 1, wherein the selection means is a checkbox.

4. The method according to claim 1, wherein the selection means is highlighting the plurality of rows of the table using at least one of a keyboard entry and a pointing device.

5. The method according to claim 1, wherein the updated value is received from a user input in a mass change row of the table.

6. The method according to claim 1, wherein the initiation means is at least one of a graphical icon and a button in the table.

7. The method according to claim 6, wherein the initiation means is part of a table control.

8. The method according to claim 1, wherein the initiation means is at least one of pull-down menu option, a button, an a graphical icon in the graphical user interface, where the initiation means is linked to software code to execute a mass data updating operation.

9. A system for updating a column value in a plurality of rows in a table, comprising:
a program memory;
a storage device; and
a processor, wherein the processor is adapted to:
(i) identify the plurality of rows in the table as a function of a provided selection means;
(ii) receive an updated value for a column in the table as a function of a user input;
(iii) provide an initiation means to trigger the updating of the column value in the plurality of rows in the table; and
(iv) update the column value in the identified plurality of rows in the table as a function of the received updated value and as a function of the triggered initiation means.

10. A computer readable medium including instructions adapted to execute a method for updating a column value in a plurality of rows in a table, comprising:
identifying the plurality of rows in the table as a function of a provided selection means;
receiving an updated value for a column in the table as a function of a user input;
providing an initiation means to trigger the updating of the column value in the plurality of rows in the table; and
updating the column value in the identified plurality of rows in the table as a function of the received updated value and as a function of the triggered initiation means.
